(19) United States
(12) Patent Application Publication
(10) Pub. No.: US 2007/0014891 A1
(43) Pub. Date: Jan. 18, 2007

(54) Dough compositions and related methods

(76) Inventors: David Gale, Plymouth, MN (US); Alexander W. Blissenbach, Woodbury, MN (US); Joseph B. Moidl, Otsego, MN (US); Steven J. Cox, Long Lake, MN (US); Vince Pestritto, Sicklerville, NJ (US); Jeffrey D. Reinke, Waconia, MN (US); Peter Statt, White Bear Lake, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/444,755

(22) Filed: May 31, 2006

Related U.S. Application Data
(63) Continuation-in-part of application No. 10/961,654, filed on Oct. 8, 2004.

(51) Int. Cl. A21D 8/02

(52) U.S. Cl. 426/20

(57) ABSTRACT

The invention relates to frozen, developed dough compositions, and related methods. Dough compositions of the present invention include a yeast ingredient, an enzyme that facilitates the production of hydrogen peroxide in the dough composition (preferably glucose oxidase), and optional acid and base chemical leavening agent. Dough compositions according to the present invention can be proofed via yeast leavening at a wide variety conditions, such as at ambient temperature or at retarder temperature.

### PRIORITY CLAIM

The present non-provisional patent Application claims priority from United States Patent Application having Ser. No. 10/961,654, filed on Oct. 8, 2004, by Bechtold et al., and titled DOUGH COMPOSITIONS AND RELATED METHODS, wherein the entirety of said patent application is incorporated herein by reference.

### FIELD OF THE INVENTION

The invention relates to developed dough compositions, and related methods. Preferably, such dough compositions can be proofed at ambient conditions or at retarder conditions.

### BACKGROUND

A large number of different varieties of dough compositions require a proofing step prior to cooking the dough. Proofing is a step that occurs prior to cooking (e.g., frying or baking), which causes a dough composition to leaven from a relatively dense dough to a lighter dough, for cooking.

Yeast is a known dough ingredient that can produce a metabolic gas such as carbon dioxide to leaven and proof a dough composition to a suitable raw specific volume prior to cooking. Dough compositions that rely exclusively on yeast for achieving a proofed raw specific volume conventionally carry out proofing at an ambient temperature or a temperature elevated above ambient temperature (e.g., in a proof-box), but below cooking temperatures. A drawback of proofing a conventional dough at an ambient temperature, where the dough relies exclusively on yeast for achieving a proofed raw specific volume is that the proofing step takes too long to accommodate dough processing at a commercial level.

Sometimes, additives are added to a dough composition to help enhance the yeast activity during proofing and associated dough characteristics such as dough volume.

Also, proofing machines (e.g., proof-boxes) are sometimes used to proof a dough in an environment having a specific range of relative humidity and a temperature above ambient temperatures, but below cooking temperatures. A drawback of proofing at such conditions is the cost of the equipment required to maintain the relative humidity and temperature within a certain range. Another drawback is that dough compositions tend to be much more sensitive to changes in temperature, time, and relative humidity when being proofed at such conditions, thereby requiring skilled training and experience to carry out the proofing operation.

Some dough compositions completely eliminate the proofing step by leavening a dough composition exclusively with chemical leavening agents, without yeast. The chemical leavening agents react to produce a leavening gas such as carbon dioxide. One drawback of this type of dough leavening is that chemical leavening agents often provide less desirable characteristics in a final cooked dough product, compared to a yeast-leavened dough product. For example, dough products leavened exclusively by chemical leavening agents may have a less desirable taste, texture, or aroma, compared to dough products that use yeast as a leavening agent.

Dough compositions are sometimes frozen, for example, to store the dough composition for later processing or preserve dough compositions for longer periods. Many commercial frozen dough compositions, especially those that are yeast-leavened, are thawed prior to cooking.

There is an ongoing need to identify new, useful, or improved compositions and methods for making dough compositions and cooked and uncooked dough products that reduce the amount of time and/or cost needed to process the dough into a cooked product.

### SUMMARY

The invention generally involves developed dough compositions that include yeast, dough-strengthening enzyme (e.g., an enzyme that facilitates the production of hydrogen peroxide in the dough composition), and optional acid and base (e.g., chemical leavening agent). Preferably, the yeast and enzyme are present in amounts that allow the dough composition to be proofed at ambient or retarder temperature in a suitable amount of time (e.g., faster than proofing a conventional dough at ambient temperature). Acid and base may be incorporated into a developed dough composition of the present invention to help reduce the tendency of or prevent “blow-out” (discussed below) from occurring.

Prepared dough compositions according to the present invention are preferably frozen in an unproofed state for later processing (e.g., proofing, cooking) and ultimately, consumption.

Dough compositions according to the present invention can be proofed at a wide variety of conditions, but are preferably proofed at ambient temperature or at retarder conditions. “Retarder conditions” means temperatures below room temperature (e.g., below 65° F.) at which thawing and proofing can occur. Retarder conditions can target 40° F. for thawing and, according to the invention, also for proofing. Examples of retarder conditions according to the invention can range from 32 to 46° F., sometimes from 33 to 45° F., e.g., from about 37 to 43° F.

It has been observed that if the levels of the yeast and enzyme are too high for a dough product of a given geometry and size, the dough product can experience “blow-out.” Blow-out can be characterized by excessive crust splitting leaving the inside crumb exposed and/or causing a large pocket (void) in the crumb portion of the loaf. This usually occurs during cooking because the dough expands too much after the crust has been set in the oven. In general, factors that can contribute to blow-out include the proofing process, dough product size, dough product geometry, leavening gas (e.g., carbon dioxide, water vapor, alcohol vapor, etc.), and/or improper dough make-up (e.g., due to dough processing).

One advantage of a dough composition of the present invention is that adding chemical leavening agent to a dough composition according to the present invention can reduce or prevent the tendency for blow-out to occur. “Blow-out” as an undesired, uncontrolled expansion of a dough during baking that results in undesired external tearing or shredding at the crust, or an unduly large internal discontinuities in the crust. An external blow-out is considered to be any tear or shred in the crust of a cooked dough product that does not occur along a score line. An internal blow-out is considered to be an open area or gap in the crumb portion of a cooked dough product that has at least one dimension of about 0.5 inch or greater. The occurrence of internal blow-out may be observed by cutting a cooked dough product to reveal a cross-sectional surface of the internal crumb.

Advantages of embodiments of dough compositions according to the present invention relate to proofing. Certain exemplary doughs can be proofed at an ambient temperature in a lesser time period as compared to a conventional frozen dough having a standard levels of yeast and an enzyme that facilitates the production of hydrogen peroxide in the dough composition. Other exemplary doughs may be proofed at retarder conditions.

Another advantage of a dough composition of the present invention is that it does not need to be proofed at proof-box conditions (e.g., in a proof-box), but can be proofed at ambient or retarder conditions while providing a proofed dough composition having substantially similar, even superior, characteristics (e.g., raw specific volume) as compared to a conventional frozen dough having a standard levels of yeast and an enzyme that facilitates the production of hydrogen peroxide in the dough composition.

Another advantage of dough compositions of the present invention is that they can exhibit a strong tolerance for being able to remain at proofing conditions for extended periods of time after proofing is completed while maintaining the proofed raw specific volume.

According to one aspect of the present invention, a frozen, developed dough composition includes the ingredients of: yeast present in an amount in the range from 2.5 to 3.75 Baker's percent; an enzyme that facilitates the production of hydrogen peroxide in the dough composition, wherein the enzyme is present in an amount in the range of from 200 to 400 parts per million based on flour; an acid; and a base, wherein the total amount of acid and base is an amount of 1.5 Baker's percent or less.

According to another aspect of the present invention, a frozen, unproofed, developed dough composition includes the ingredients of: yeast present in an amount in the range from 2.5 to 3.75 Baker's percent; glucose oxidase present in an amount in the 30 range of from 200 to 400 parts per million based on flour; and chemical leavening agent present in an amount of 1.5 Baker's percent or less.

According to another aspect of the present invention, a method of proofing a frozen, unproofed, developed dough composition, includes the steps of: providing a frozen, unproofed, developed dough composition; thawing the frozen dough composition; and after thawing, proofing the dough composition at ambient temperature to provide a proofed dough composition. The composition includes the ingredients of: yeast present in an amount in the range from 2.5 to 3.75 Baker's percent; an enzyme that facilitates the production of hydrogen peroxide in the dough composition, wherein the enzyme is present in an amount in the range of from 200 to 400 parts per million based on flour; an acid; and a base, wherein the total amount of acid and base is an amount of 1.5 Baker's percent or less.

In one aspect, the invention relates to a frozen, developed dough composition comprising yeast in an amount in the range from 2 to 6 Baker's percent on a dry yeast basis; and dough-strengthening enzyme, wherein the dough composition is capable of proofing at retarder conditions.

In another aspect the invention relates to a method of proofing a frozen, unproofed, developed dough composition. The method includes: providing a frozen, unproofed, developed dough composition comprising yeast in an amount in the range from 2 to 6 Baker's percent on a dry yeast basis and dough-strengthening enzyme; thawing and proofing the frozen dough composition at retarder conditions for a time in the range from 8 to 48 hours; placing the dough at ambient temperature in the range from 65 to 85 degrees Fahrenheit for a time of less than 60 minutes; and then baking the dough.

In preferred embodiments, the acid and base comprise chemical leavening agent.

As used herein the term “unproofed” is meant to indicate a dough product that has not been subjected to conditions effective to at least partially proof the dough product, i.e., to cause the dough product to increase in volume 10% or more.

The term “Baker's percent” is well-known in the dough formulation arts and refers to a method of reporting the weight of individual dough composition ingredients as a percentage of the total flour weight. Thus, the total flour is reported as 100 Baker's percent and the sum of the Baker's percentages for all the dough composition ingredients is greater than 100.

### DETAILED DESCRIPTION

The invention relates to developed dough compositions that can be proofed at a variety of conditions, including at ambient conditions and at retarder conditions. These developed dough compositions are of the types of dough compositions that are subjected to a separate proofing step prior to baking to allow yeast to proof the dough composition. Preferably, dough compositions according to the present invention are frozen in an unproofed state, thawed, proofed at ambient or retarder conditions, and then cooked.

Developed doughs are generally understood to include doughs that have a developed gluten matrix structure; a stiff, elastic rheology; and that are capable of forming a matrix of relatively elastic bubbles or cells that hold a leavening gas while the dough expands, leavens, or rises, prior to or during cooking (e.g., baking). Features that are sometimes associated with a developed dough, in addition to a stiff, elastic rheology, include a liquid component content, e.g., water content, that is relatively high; a high protein content; a relatively low fat content; and processing steps that include time to allow the dough ingredients (e.g., protein) to interact and “develop” or strengthen the dough. Developed doughs in general can be yeast-leavened and are normally relatively less dense prior to and after cooking (i.e., on average have a relatively higher specific volume) compared to un-developed doughs. Examples of specific types of doughs that can be considered to be developed doughs include doughs for pizza crust, breads (loaves, French bread loaves, Kaiser rolls, hoagie rolls, dinner rolls, baguettes, focaccia, flat breads, bread sticks), raised donuts and sweet rolls, cinnamon rolls, croissants, Danishes, pretzels, etc.

In contrast to developed doughs, doughs generally referred to as un-developed (or “non-developed”) doughs have an un-developed (or less developed) matrix structure resulting in a non-elastic (or less elastic) rheology and, therefore, have relatively lower raw and baked specific volumes due to reduced gas retention by the dough. Examples of un-developed types of doughs include cookies, cakes, cake donuts, muffins, and other batter-type doughs such as brownies, biscuits, etc.

Developed dough compositions according to the present invention include yeast, an enzyme that facilitates the production of hydrogen peroxide in the dough composition (e.g., glucose oxidase), and optional acid and base chemical leavening agents.

In general, dough compositions can be caused to expand (leaven) by any leavening mechanism, such as by one or more of the effects of: entrapped gas such as entrapped carbon dioxide, entrapped oxygen, or both; a laminated dough structure; by action of chemical leavening agents; or by action of a biological agent such as a yeast. Thus, a leavening agent may be an entrapped gas such as layers or cells (bubbles) that contain carbon dioxide, water vapor, or oxygen, etc.; any type of yeast (e.g., cake yeast, cream yeast, dry yeast, etc.); or a chemical leavening system, e.g., containing a basic chemical leavening agent and an acidic chemical leavening agent that react to form a leavening gas such as carbon dioxide.

Yeast can contribute to the proofing of a dough composition of the present invention by generating a gas (e.g., carbon dioxide) due to metabolic activity of yeast. As used in the invention, yeast can contribute to proofing a dough composition at a wide variety of conditions. For example, yeast can contribute to proofing a dough composition at retarder conditions, ambient conditions, proof box conditions, and/or in a cold oven that is gradually increased in temperature to a desired baking temperature. Preferably, yeast contributes to proofing at retarder or ambient conditions.

Any yeast suitable for proofing a dough composition according to the present invention (preferably at ambient temperature) can be used. For example, such suitable yeast can include yeasts that are active in the temperature range for normal processing at refrigerated or ambient temperatures, including yeast that is commonly referred to as Baker's yeast (saccharomyces cerevisieae species).

Suitable yeast can be incorporated into a dough composition of the present invention on a dry yeast basis and/or as a yeast ingredient which includes one or more other ingredients (e.g., moisture) that are typically present in commercially available forms of yeast.

A yeast ingredient included in the inventive dough composition may be any type of suitable yeast ingredient that can leaven and contribute to proofing a dough composition at the desired conditions, for example, at the preferred ambient or retarder conditions. Useful yeast ingredients that can contribute to proofing a dough composition at least at ambient conditions include, for example, crumbled yeast (also called cake yeast or compressed yeast), fresh yeast, bulk yeast, yeast cream, live active yeast, instant active dry yeast, instant dry yeast, dry active yeast, protected active dry yeast, frozen yeast, and combinations of these. Yeast ingredients such as these can differ in the amount of moisture contained in the particular yeast ingredient, which can in turn influence how much of a particular yeast ingredient should be combined with other dough composition ingredients to provide a dough composition according to the invention. This selection of differing amounts among different yeast ingredients will be readily understood by those skilled in the dough and baking arts. For example, crumbled yeast (cake yeast and compressed yeast ingredients) has a higher moisture content than dry active yeast ingredient and cream yeast has a higher moisture content than crumbled yeast. Crumbled yeast, cake yeast, and compressed yeast have a moisture content of about 70% by weight of the yeast ingredient (30% by weight of the yeast ingredient as solids). A typical conversion factor for determining a suitable amount of cream yeast based on a known amount of crumbled yeast is as follows: 1% crumbled yeast per 1.7% cream yeast. Thus, due to the difference in moisture content, a greater total amount of cream yeast ingredient (including more water) would likely be needed in place of a lesser moisture content yeast ingredient such as fresh crumbled yeast, cake yeast, or compressed yeast. To be clear, the total amount of the yeast portion of the yeast ingredient that is added should be similar, but the amount of moisture included among the different types of yeast ingredients can differ (e.g., crumbled yeast versus cream yeast), causing different total amounts among the different moisture-content yeast ingredients to be suitable for use in dough compositions according to the present invention.

Yeast is included in a dough composition of the present invention in an amount that helps proof the dough at a desired set of conditions (e.g., retarder or ambient conditions). In one embodiment, yeast is present in an amount in the range from 2 to 6 Baker's percent on a dry weight basis, e.g., from 3 to 5 Baker's percent on a dry basis, such as from 2.5 to 3.75 Baker's percent on a dry basis. In terms of a preferred amount of a preferred yeast ingredient, crumbled yeast ingredient can be incorporated into a dough composition of the present invention in an amount in the range from 7.5 to 12.5 Baker's percent (this assumes crumbled yeast has 30% solids), more generally from 8 to 18 Baker's percent, or from 10 to 16 Baker's percent on a crumbled yeast basis. Other yeast ingredients that have similar moisture content to crumbled yeast can be used in this same range. Yeast ingredients that have different (higher or lower) percent moisture can be used in higher or lower amounts (respectively), but still in amounts that will provide the same or similar amount of the yeast component of the yeast ingredient.

While not being bound by theory, it is believed that such a relatively high amount of yeast (e.g., an amount in the range from 2 to 6 Baker's percent, such as from 2.5 to 3.75 Baker's percent) in combination with relatively high amounts of enzyme (discussed below) can cause a dough composition of the present invention to experience “blow-out” (discussed above) if the yeast ingredient and enzyme are not properly balanced with other types and amounts of dough ingredients. As discussed below, an acid and base (e.g., chemical leavening agent) can optionally be incorporated into a developed dough composition of the present invention to help reduce the tendency of or prevent blow-out from occurring. Geometry and size of the dough product can also influence whether a dough composition experiences blow-out (discussed herein).

Enzyme can be included in the dough to allow for desired proofing properties and increase specific volume and oven spring, by strengthening the gluten matrix of a dough. Exemplary enzymes may strengthen a dough matrix by oxidizing protein in a dough matrix, to produce disulfide bonds, which results in a strengthened dough matrix that allows for better expansion of the dough and better gas-retention properties, resulting in improved oven spring and specific volume. The type of enzyme can be any type of enzyme that improves strength of a dough matrix and results in better expansion and gas-retention properties. Examples include enzymes that facilitate the production of peroxide, (e.g., hydrogen peroxide), which can result in increased strength of a dough matrix and enhanced dough volume, including one or more of raw specific volume and baked specific volume. Enzymes that facilitate the production of peroxide or hydrogen peroxide, or that otherwise increase strength of a dough matrix and improve dough volume, include enzymes that are well-known in the dough making and dough baking arts. Such exemplary enzymes for use in dough compositions of the present invention include glucose oxidase, hexose oxidase, lipoxygenase, lipase, amylase, and the like. In one embodiment of the present invention, the enzyme is selected from the group consisting of glucose oxidase, hexose oxidase, lipase, and combinations thereof. In another embodiment of the present invention, the enzyme is selected from the group consisting of glucose oxidase, hexose oxidase, and combinations thereof. In still another embodiment of the present invention, the enzyme comprises glucose oxidase or a mixture of glucose oxidase and amylase. Glucose oxidase can facilitate the production of hydrogen peroxide in a dough composition of the present invention by facilitating the breakdown of glucose into gluconic acid and hydrogen peroxide.

Enzymes that strengthen a dough matrix can be used in any amount effective to produce desired leavening properties of a dough, such as the ability to leaven at retarder or ambient conditions and to result in desired oven spring and baked specific volume. Enzymes are generally included in a dough formulation as part of an enzyme ingredient that may include enzyme (normally in a small amount) with other constituents. The amount of enzyme material in an enzyme ingredient can be characterized in terms of “units” of enzyme per amount of the enzyme ingredient. An example of a useful enzyme ingredient is FUNGAMYL® SUPER BR enzyme ingredient, which includes 440 glucose oxidase units (GODU units) per gram of FUNGAMYL® SUPER BR enzyme ingredient. FUNGAMYL® SUPER BR enzyme ingredient also includes 300 Alpha Amylase Units per gram of ingredient (i.e., 300 FAU-F per gram enzyme ingredient).

According to the description, the amount of enzyme or enzyme ingredient in a dough composition can be any amount that is effective to produce a dough as described, preferably having desired proofing properties and oven spring, which provide specific volumes as also described. Exemplary amounts of glucose oxidase may be in the range from 2 to 30 glucose oxidase units (GODU) per 100 grams flour, such as from 2 to 20 GODU per 100 grams flour. These amounts can roughly correspond to useful ranges of FUNGAMYL® SUPER BR enzyme ingredient, such as amounts in the range 0.0045 to 0.068 Baker's percent FUNGAMYL® SUPER BR enzyme ingredient; e.g., from 0.008 to 0.064 Baker's percent FUNGAMYL® SUPER BR enzyme ingredient, e.g., from 0.01 to 0.032 Baker's percent FUNGAMYL® SUPER BR enzyme ingredient. Other enzymes that strengthen a dough matrix, e.g., by facilitating production of hydrogen peroxide, may be used in amounts that correspond to similar amounts of glucose oxidase based on functionality for providing desired dough properties (e.g., oven spring, specific volume) or based on actual amounts of enzyme.

As mentioned, enzymes that strengthen a dough matrix, e.g., by facilitating the production of a peroxide such as hydrogen peroxide in dough compositions are often commercially available as mixtures of the enzyme and one or more other ingredients (e.g., other types of enzymes) that contribute to certain desired dough properties. Such enzyme mixtures can be incorporated into dough compositions of the present invention. For example, a preferred commercial form of glucose oxidase is sold under the trade name FUNGAMYL® SUPER BR from Novozymes and is a mixture of 300 units per gram fungyl alpha amylase and 440 units per gram glucose oxidase. Other commercial examples include Grindamyl S758 from Danisco (a glucose oxidase-containing enzyme ingredient) and Surebake 700 from Danisco (a hexose oxidase-containing enzyme ingredient).

According to the present invention, a dough-strengthening enzyme, e.g., enzyme that facilitates the production of hydrogen peroxide in dough compositions, can be incorporated into a dough composition of the present invention in an amount effective to help provide a proofed dough composition having a suitable specific volume (i.e., one or more of suitable raw specific volume and baked specific volume), where the proofing can occur at a given set of conditions (e.g., retarder or ambient conditions). In preferred embodiments, the enzyme (preferably glucose oxidase) is present in an amount in the range of from 200 to 400 parts per million based on flour.

While not being bound by theory, it is believed that because such enzymes can be so powerful in enhancing dough volume, certain dough compositions according to the present invention can experience “blow-out” (discussed above). For example, when a relatively high amount of the enzyme (glucose oxidase in an amount in the range of from 200 to 400 ppm based on flour) is combined with a relatively high amount of yeast (an amount in the range from 2.5 to 3.75 Baker's percent) and formed into a large loaf dough product (e.g., French bread loaf) having a size in the range from 14-24 ounces, the enhanced yeast activity can cause the dough product to blow-out during cooking. While not being bound by theory, it is believed that the heat transfer properties for such a large dough product having the relatively high amounts of yeast and enzyme are such that the bulk dough composition takes longer to reach cooking temperature, thereby allowing the enhanced yeast activity to occur for a relatively longer period of time (note: yeast activity substantially reduces/stops (e.g., the yeast die) when a bulk dough composition reaches a typical cooking temperature). During such extended period of time of enhanced yeast activity is such that it can cause blow-out to occur. It is believed that decreasing the size of a given dough product having the relatively high amounts of yeast and enzyme according to the present invention can help reduce or prevent the tendency for blow out to occur because the bulk dough composition would take less time to reach cooking temperature, thereby inhibiting the enhanced yeast activity described above (e.g., killing the yeast) in a relatively shorter period of time. The tendency for blow-out to occur can also be reduced or prevented by incorporating a suitable amount of acid and base (discussed below). In certain embodiments, the tendency for blow-out to occur can be reduced or prevented by using both 1) a smaller size for a given dough product and 2) an acid and base.

Acid and base chemical leavening agents can optionally be incorporated into a dough composition of the present invention to help reduce the tendency of or prevent blow-out from occurring. According to the present invention, chemical leavening agent can be incorporated into a dough composition as an acid and base. Using chemical leavening agent to prevent blow-out may seem counterintuitive because chemical leavening agent is widely known as a gas producing agent (i.e., produces carbon-dioxide) which may intuitively be thought to increase the likelihood of blow-out. However, it has been observed that adding an acid and base such as chemical leavening agent to a dough composition having yeast and dough-strengthening enzyme, such as an enzyme that facilitates the production of hydrogen peroxide, according to the present invention, can prevent any additional dough volume increase or even reduce dough volume. Advantageously, adding chemical leavening agent to a dough composition according to the present invention can reduce or prevent the tendency for blow-out to occur.

While certain embodiments of the invention can include chemical leavening acid, chemical leavening base, or both, for leavening or for preventing blow-out, other embodiments of the invention also do not include any acid or base, and can specifically exclude acid and base, while still exhibiting useful properties and while also not exhibiting blow-out.

Chemical leavening agent useful in the present invention can include any type or combination of leavening agent understood to act as a chemical leavening agent. In general, chemical leavening agent includes an acidic active agent and a basic active agent, the two of which can react to produce carbon dioxide.

Acidic active agents are generally known in the dough and bread-making arts, with some examples including leavening phosphates such as SALP (sodium aluminum phosphate), SAPP (sodium acid pyrophosphate), and monosodium phosphate, monocalcium phosphate monohydrate (MCP), anhydrous monocalcium phosphate (AMCP), and dicalcium phosphate dihydrate (DCPD); organic acids; glucono-delta-lactone; and others. Commercially available acidic active agents can include those sold under the trade names: Levn-Lite® (SALP), Pan-O-Lite® (SALP+MCP), STABIL-9® (SALP+AMCP), PY-RAN® (AMCP), and HT® MCP (MCP). SALP and SAPP can impart desirable flavor characteristics when used, alone or in combination, in dough compositions of the present invention. In certain embodiments, chemical leavening agent comprises acidic active agent selected from the group consisting of sodium acid pyrophosphate, sodium aluminum phosphate, and combinations thereof.

Optionally, acidic active ingredient for use in dough compositions of the present invention can be encapsulated. Encapsulated particles containing acidic active agent are generally known, and can be prepared by methods known in the baking and encapsulation arts. An example of a method for producing encapsulated acidic active agent is the use of a fluidized bed.

Acidic active agents can be either relatively soluble (“fast-acting”) or relatively insoluble (“slow-acting”). Such characterization of acidic active agents is well-known in the dough making art. Both fast-acting and slow-acting acidic active agents can be used in dough compositions of the present invention.

Acidic active agent can be incorporated into a dough composition of the present invention at least in an amount sufficient to prevent or reduce blow-out from occurring (discussed above). Such an amount may or may not be an amount to neutralize the basic active agent. Preferably, the amount of acidic active agent incorporated into a dough composition of the present invention is an amount that is stoichiometric to the amount of basic active agent, with the exact amount being dependent on the particular acidic active agent that is chosen.

Useful basic active agents are generally known in the dough and baking arts, and include soda, i.e., sodium bicarbonate (NaHCO₃), potassium bicarbonate (KHCO₃), ammonium bicarbonate (NH₄HCO₃), etc. These and similar types of basic active agents are generally soluble in an aqueous phase of a dough composition.

Optionally, basic active agent for use in a dough composition of the present invention can be encapsulated. Encapsulated particles containing basic active agent are generally known, and can be prepared by methods known in the baking and encapsulation arts. An example of a method for producing encapsulated basic active agent is the use of a fluidized bed.

Basic active agent can be incorporated into a dough composition of the present invention at least in an amount sufficient to prevent or reduce blow-out from occurring (discussed above). Such an amount may or may not be an amount to neutralize the acidic active agent. Preferably, the amount of basic active agent incorporated into a dough composition of the present invention is an amount that is stoichiometric to the amount of basic active agent. The amount of each acid and base needed to neutralize each other depends on the specific acid and base used in the acid-base combination. For example, sodium aluminum phosphate (SALP) and sodium bicarbonate can neutralize each other when present in a 1:1 weight ratio. That is, one pound of sodium bicarbonate can neutralize one pound of SALP. As another example, 72 pounds of baking soda can neutralize 100 pounds of sodium acid pyrophosphate (SAPP). As yet another example, 119 pounds of potassium bicarbonate can neutralize 100 pounds of SALP. As yet another example, 94 pounds of ammonium bicarbonate can neutralize 100 pounds of SALP.

If an acid and base are not in a neutralizing ratio with respect to each other (e.g., 1 part by weight SALP to 0.5 parts by weight baking soda), color and flavor can be affected but the tendency for blow-out can still be reduced or prevented.

The total amount of acid and base (e.g., chemical leaving agent) used in a dough composition of the present invention is at least effective to reduce or prevent blow out from occurring as described above. In preferred embodiments of the present invention, a dough composition includes chemical leavening agent in an amount of 1.5 Baker's percent or less (i.e., in an amount from 0 to 1.5 Baker's percent). In certain embodiments of the present invention, a dough composition can include chemical leavening agent in an amount from 0.5 to 1.5 Baker's percent. In other certain embodiments of the present invention, a dough composition can include chemical leavening agent in an amount of 1.5 Baker's percent. In an example with specific acidic and basic active agents, SALP and sodium bicarbonate in the preferred weight ratio of 1:1 can be incorporated into a dough composition in an amount in the range from 0.25 to 1 Baker's percent.

An acidic active agent and basic active agent can be incorporated into a dough composition of the present invention as separate ingredients and/or as a mixture of the two. A mixture of acidic active agent and basic active agent is commonly known as baking powder. Preferably baking powder is used. Preferred baking powder includes sodium aluminum phosphate (SALP) as the acidic active agent and sodium bicarbonate as the basic active agent.

A dough composition according to the present invention can include other ingredients generally known in the dough and bread-making arts, typically including flour, a liquid component such as oil or water, sugar (e.g., glucose), and optionally additional ingredients such as shortening, salt, sweeteners, dairy products, egg products, processing aids, emulsifiers, particulates, dough conditioners, yeast as a flavorant, other flavorings, etc. Many formulations for developed doughs are known to those skilled in the dough and dough cooking (e.g., baking and/or frying) arts and are readily available to the public in commercial cookbooks.

A flour component can be any suitable flour or combination of flours, including glutenous and nonglutenous flours, and combinations thereof. The flour or flours can be whole grain flour, wheat flour, flour with the bran and/or germ removed, or combinations thereof. Typically, a developed dough composition can include between about 30% and about 70% by weight flour of the total dough composition (i.e., 100 Baker's percent). Exemplary embodiments of the invention can include high protein flour, which refers to flour having at least 10 percent by weight protein, e.g., from 10 to 16 weight percent protein based on the total weight of the flour.

Examples of liquid components include water, milk, eggs, and oil, or any combination of these. For example, a liquid component may include water, e.g., in an amount in the range from about 45 to 60 Baker's percent. Water may be added during processing in the form of ice, to control the dough temperature in-process; the amount of any such water used is included in the amount of liquid components. The amount of liquid components included in a developed dough composition can depend on a variety of factors including the desired moisture content and rheological properties of the dough composition.

A dough composition of the present invention can optionally include egg or dairy products such as milk, buttermilk, or other milk products, in either dried or liquid forms. Non-fat milk solids which can be used in the dough composition can include the solids of skim milk and may include proteins, mineral matter, and milk sugar. Other proteins such as casein, sodium caseinate, calcium caseinate, modified casein, sweet dairy whey, modified whey, and whey protein concentrate can also be used in these doughs.

A dough composition of the present invention can optionally include fat ingredients such as oils (liquid fat) and shortenings (solid fat). Examples of suitable oils include soybean oil, corn oil, canola oil, sunflower oil, and other vegetable oils. Examples of suitable shortenings include animal fats and hydrogenated vegetable oils. If included in a developed dough, fat is typically used in an amount less than about 10 percent by weight, often less than 5 percent by weight of the total dough composition. For example, certain embodiments include soy oil in an amount in the range from 1 to 2 Baker's percent.

A dough composition of the present invention can optionally include one or more sweeteners, either natural or artificial, liquid or dry. Examples of suitable dry sweeteners include lactose, sucrose, fructose, dextrose, maltose, corresponding sugar alcohols, and mixtures thereof. Examples of suitable liquid sweeteners include high fructose corn syrup, malt, and hydrolyzed corn syrup.

A dough composition of the present invention can further include additional flavorings, for example, salt, such as sodium chloride and/or potassium chloride; whey; malt; yeast extract; yeast (e.g., inactivated yeast); spices; vanilla; etc.; as is known in the dough product arts. Certain embodiments include salt in an amount in the range from 1.5 to 2 Baker's percent.

As is known, dough compositions can also optionally include other additives, colorings, and processing aids such as emulsifiers, strengtheners (e.g., ascorbic acid), preservatives, and conditioners. Certain embodiments include ascorbic acid in an amount in the range from 120 to 200 ppm. Suitable emulsifiers include lecithin, mono- and diglycerides, polyglycerol esters, and the like, e.g., diacetylated tartaric esters of monoglyceride (DATEM) and sodium stearoyl-2-lactylate (SSL). Acidulants commonly added to foods include lactic acid, citric acid, tartaric acid, malic acid, acetic acid, phosphoric acid, and hydrochloric acid.

Conditioners, as are known in the dough products art, can be used to make the dough composition tougher, drier, and/or easier to manipulate. Examples of suitable conditioners can include azodicarbonamide, potassium sulfate, potassium sorbate, L-cysteine, L-cysteine hydrochloride, sodium bisulfate, mono- and di-glycerides, polysorbates, sodium bisulfite, sodium stearoyl lactylate, ascorbic acid and diacetyltartaric acid esters of mono- and di-glycerides (DATEM), and the like. These conditioners may add functionality, reduce mix times, and provide softness to the doughs to which they are added. Certain embodiments include L-cysteine (1.1% solution) in an amount in the range from 0 to 40 ppm.

Embodiments of dough compositions can also, optionally, include a “concentrated protein ingredient,” which refers to non-wheat-flour ingredients that contains a substantial concentration of gluten or another protein that provides improved gas holding capacity to a developed dough. Non-gluten proteins that may be useful in a concentrated protein ingredient may include proteins such as albumen; casein, casienates; milk proteins such as whey protein, modified whey protein; soy protein; modified soy protein; legume proteins, protein isolates; and the like, any of which may be used alone or in combination with gluten. Certain concentrated gluten ingredients can include gluten at a concentration of at least 20 weight percent gluten based on the total weight of the gluten ingredient, e.g., at least 75 weight percent gluten based on total weight of the gluten ingredient. While dough compositions of the invention may include wheat flour, and wheat flours can include gluten, standard wheat flours (including high gluten wheat flour) are not considered concentrated protein or “gluten ingredients” for purposes of this description. Still, the total amount of protein, or the total amount of gluten in a dough composition can include an amount of gluten that is part of a gluten ingredient or a concentrated protein ingredient, in combination with any amount of protein or gluten that is present due to a wheat flour ingredient (e.g., a high gluten flour).

Vital wheat gluten is an example of a concentrated protein ingredient (here, a “concentrated gluten ingredient”), and normally is an ingredient in the form of a protein powder having the ability to reconstitute rapidly in water to give a homogenous, viscoelastic, coherent mass with similar properties as the native flour protein would possess when washed out in the form of wet gluten. Starch and bran normally present in a wheat flour have been removed from this ingredient. The typical commercial vital wheat gluten ingredient can contain from 75 to 80 percent by weight total protein, 10 percent by weight residual starch, and 5 percent by weight lipid (all dry weight basis), with the remainder being minerals, fiber, and other impurities. Moisture content is typically from 8 to 9 percent based on weight, not normally in excess of 10 percent by weight.

A concentrated protein ingredient such as vital wheat gluten can be used in any useful or desired amount, such as in an amount up to 10 Baker's percent, e.g., from 0.1 to 7 Baker's percent, from 0.2 to 5 Baker's percent, or from 0.2 to 3 Baker's percent.

According to embodiments of the invention, a thickener can be included in a dough as described, to provide improved shape and mechanical properties of the dough during and after cooking. Exemplary thickeners, in doughs that include chemical leavening agent and in those that do not, have been found to be effective in preventing collapse of the dough and excessive flow during baking. Examples of thickeners include high molecular weight polysaccharides, such as xanthan gum, carboxymethyl cellulose, methyl cellulose, hydroxypropyl cellulose, hydroxypropylmethyl cellulose, etc. The amount of thickener can be any useful amount, and can be sufficient for the purpose of preventing collapse of the dough, excess flow during baking, or both. Exemplary amounts can be in the range up to 1 Baker's percent, e.g., from 0.1 to 0.5 Baker's percent.

A bran or fiber can be included in any of the dough compositions described herein, to further prevent or reduce blow-out, as is described in Assignee's copending U.S. patent application Ser. No. 11/343,348, filed Jan. 31, 2006, titled “Method of Reducing Voids in Dough,” by Joseph B. Moidl et al., the entirety of which is incorporated herein by reference.

Dough compositions described herein can be prepared according to methods and steps that are presently known (e.g., the sponge method and straight-dough method), or developed in the future, in the dough and dough product arts for making developed doughs. Exemplary steps include steps of mixing or blending ingredients, folding, lapping with and without fat or oil, forming, shaping, cutting, rolling, filling, etc., which are steps well known in the dough and baking arts for making developed doughs (i.e., steps that can provide a developed gluten matrix structure and a stiff, elastic rheology which are characteristic of a developed dough).

If prepared dough compositions of the present invention are packaged and/or frozen, the dough compositions can be unproofed, partially proofed, or pre-proofed. Preferably, prepared dough compositions of the present invention are frozen in an unproofed state.

Prepared developed dough compositions of the present invention can be packaged in any conventional package, preferably in an unproofed state. A package may be a standard flexible package of a flexible film (e.g., plastic) that contains one or more portions (e.g., loaves, rolls, etc.) either loosely or supported by a rigid structure such as cardboard or plastic. The package may be included in a larger package such as a cardboard box for sale and distribution.

Prepared dough compositions of the invention are preferably frozen (32° F. and below) and unproofed. If the prepared dough compositions have been packaged, the package and contents may be stored frozen, and individual portions of the dough, e.g., individual rolls, can be removed for thawing and proofing. Typically, many dough portions may be removed from frozen storage at the same time, and the portions will be arranged on a tray or otherwise positioned for thawing and/or proofing.

Thawing a frozen, developed dough composition of the present invention can be performed using methods known in the art. Exemplary suitable methods include subjecting the frozen dough composition to retarder conditions, ambient conditions, proof-box conditions, and even in a cold oven for a time suitable to thaw the dough composition so that it can be proofed prior to cooking. Preferably, thawing is performed at retarder conditions. Retarder conditions are well-known in the art and generally include temperatures above freezing (32° F.) and below the lower end of ambient temperatures (65° F.). Preferred retarder temperatures include those in the range from 33° F. to 42° F. Retarder conditions can be provided by equipment such as retarders, which are well-known in the dough processing arts. Preferably, a frozen dough composition of the present invention is positioned in a rack of the type typically used in thawing procedures and covered so that the dough does not dry out during thawing. Thawing a dough composition of the present invention occurs in a time period from 6 to 30 hours, preferably from 10 to 20 hours.

After thawing the dough can be proofed. Proofing can occur at a wide variety of conditions such as retarder conditions, ambient conditions, proof-box conditions, and even in a cold oven. Retarder conditions and proof-box conditions are typically provided with equipment well-known in the dough processing arts such as retarders and proof-boxes, respectively. As used herein, ambient conditions means an atmosphere having a relative humidity from 0% to saturation (about 95%) and a temperature in the range from 65° F. to 85° F., preferably from 65° F. to 80° F., and even more preferably about 75° F. In preferred embodiments, a dough composition of the present invention is proofed at ambient temperature. Preferably, a dough composition of the present invention is positioned in a rack of the type typically used in proofing procedures and covered so that the dough does not dry out during proofing. Depending of factors such as dough mass and/or dough configuration a dough composition of the present invention can proof at an ambient temperature in a time period from 30 minutes to 6 hours, preferably from 1 to 4 hours. For example, a French bread loaf according to the present invention and having a size in the range from 14-24 ounces can proof at ambient conditions in a time period less than 120 minutes.

Optionally, a dough can be proofed (e.g., thawed and proofed) at retarder conditions. Thawing from frozen and proofing, or proofing alone after thawing, may take, e.g., from 4 to 48 hours, e.g., 6 to 30 hours, or 10 to 20 hours. At the end of such time the dough may be ready for cooking and may exhibit a raw specific volume of a proofed dough, such as from 2.5 to 5 cc/g or from 2.5 to 4.5 cc/g. The proofed dough may be immediately cooked, or may if desired by rested at ambient temperature to allow the temperature of the dough to reach room temperature (e.g., 65 to 85 degrees Fahrenheit), which may take less than 60 minutes, e.g., from 0 to 60 minutes at room temperature.

One advantage of a dough composition according to the present invention is that it can be proofed at an ambient temperature in a lesser time period as compared to a conventional frozen dough having a standard levels of yeast and an enzyme that facilitates the production of hydrogen peroxide in the dough composition.

Another advantage of a dough composition of the present invention is that it does not need to be proofed at proof-box conditions (e.g., in a proof-box), but can be proofed at ambient conditions while providing a proofed dough composition having substantially similar, even superior, characteristics (e.g., raw specific volume) as compared to a conventional frozen dough having a standard levels of yeast and an enzyme that facilitates the production of hydrogen peroxide in the dough composition. In certain embodiments, proofing a dough composition of the present invention at ambient conditions can provide a proofed dough product having a raw specific volume in the range from 0.9 to 1.3 cubic centimeters per gram.

Although a dough of the present invention could be proofed at proof-box conditions, by eliminating the requirement of proof-box conditions, cost savings can be realized by, e.g., not having to provide equipment (e.g., a proof-box) for a conditioned atmosphere. Proof-box conditions are well-known in the art and include a temperature greater than 85° F. or 90° F. and a relative humidity in the range of 80-95%. Also, although a dough composition of the present invention could be proofed at retarder conditions (e.g., in a retarder), proofing at ambient conditions can be more cost effective by, e.g., not having to provide equipment (e.g., a retarder) for such a conditioned atmosphere.

Another advantage of eliminating the requirement that a dough be proofed at proof-box conditions is that monitoring and controlling the proofing atmosphere (i.e., proofing conditions) at, e.g., ambient conditions is much less demanding than proofing at proof-box conditions. This can be a significant benefit to certain commercial proofing operations where relatively unskilled bakery workers are sometimes responsible for proofing a frozen, unproofed dough composition. In general, many prior art doughs that are proofed at proof-box conditions are relatively much more sensitive to changes in the proofing atmosphere (e.g., changes in one or more of relative humidity and temperature) and typically require skilled training and experience to provide a proofed dough composition of suitable quality. Advantageously, a dough composition of the present invention being proofed at ambient conditions is much less sensitive to changes in the proofing atmosphere and, therefore, can be proofed by a relatively less skilled worker.

Proofing a dough composition in a cold oven is well known and can include, for example, taking a frozen, unproofed dough product from frozen conditions and placing it in a cold oven where the dough product can thaw and proof as the oven temperature is gradually increased to a desired baking temperature.

After proofing, a proofed dough composition of the present invention can be directly cooked, without any additional floor time, or can sit in its proofed condition at a given set of proofing conditions (retarder conditions, ambient conditions, or proof-box conditions, but preferably ambient conditions) for a period of time as needed or desired (e.g., for scheduling) prior to cooking. This may be necessary or desirable, for example, if a dough composition is thawed and proofed overnight at ambient conditions and cooked in the morning. Dough compositions of the present invention can exhibit a strong tolerance for being able to remain at proofing conditions for extended periods of time after proofing is completed while maintaining the proofed raw specific volume. Proofed dough compositions of the present invention may be allowed to sit at, e.g., ambient conditions after proofing for a period of time that will not negatively impact the proofed dough properties (e.g., raw specific volume) or cooked dough properties (e.g., baked specific volume). Depending of factors such as dough mass and/or dough configuration a dough composition of the present invention can sit at, e.g., ambient conditions after proofing for a time period in the range from 0 to 8 hours, preferably up to 4 hours, e.g., up to one hour or from 30 to 60 minutes, or from 1 to 4 hours, or for any other time that may be useful, convenient, or otherwise desired. At any time during that period (e.g., up to 8 hours), the dough composition can be removed from proofing conditions for cooking. This feature of the inventive composition and methods provides for very flexible scheduling of a cooking step, because the dough composition can be cooked directly from the ambient without the need for a time-consuming intermediate proofing step in a proof-box (i.e., at proof-box conditions). Without being bound by theory, it is believed that the combination of yeast and enzyme that facilitates the production of hydrogen peroxide in a dough composition according to the present invention sufficiently strengthens the dough matrix to provide such enhanced tolerance.

Proofed dough compositions of the present invention are typically cooked following proofing. Methods of cooking are well known in the dough and baking arts, and typically can include baking or flying for a yeast-leavened, developed dough composition. More specifically, a dough composition of the invention may be cooked by conventional means, such as being baked in an oven (e.g., conventional, convection, impingement, microwave) or fried to provide a suitable baked specific volume. Baking a dough composition of the present invention in an oven can occur with or without steam injection. Baking in an oven with steam injection is well-known in the dough baking arts and typically includes injecting steam into an oven at the beginning of the bake cycle. Baking with steam injection can help a dough product maintain shape and structure, and provide certain appearance and texture characteristics. In certain embodiments, baking can occur at a temperature in a range from 350° F. to 385° F. and in a time period from 12 to 35 minutes.

A baked dough composition of the invention can have a baked specific volume in the range from about 3 to 8.5 cubic centimeters per gram, depending on the type of dough product ultimately made. In certain embodiments, dough products have a baked specific volume of 3 to 3.5 cubic centimeters per gram. In other embodiments, dough products have a baked specific volume of 4 to 8.5 cubic centimeters per gram. In still other embodiments, dough products have a baked specific volume of 5 to 8.5 cubic centimeters per gram. And in still other embodiments, dough products have a baked specific volume of 5 to 7 cubic centimeters per gram.

A cooked dough product made with a dough composition of the present invention can be present in a variety of sizes, such as from 0.5 to 30 ounces, e.g., from about 1.25 to about 24 ounces. In certain embodiments, a dough composition of the present invention can be formed into a dough product having a size in the range from 1.25 to 4.5 ounces. In other embodiments, a dough composition of the present invention can be formed into a dough product having a size in the range from 5.0 to 13.5 ounces. In other embodiments, a dough composition of the present invention can be formed into a dough product having a size in the range from 14 to 24 ounces. In still other embodiments, a dough composition of the present invention can be formed into a dough product having a size of 3.5 ounces or less, e.g., from 0.5 to 3.5 ounces.

A cooked dough product made with a dough composition of the present invention can be one or more of a wide variety of developed dough products that have been yeast leavened, for example, doughs for pizza crust, breads (loaves, French bread loaves, Kaiser rolls, hoagie rolls, dinner rolls, baguettes, focaccia, flat breads, bread sticks), raised donuts and sweet rolls, cinnamon rolls, croissants, Danishes, pretzels, etc. Preferably, a cooked dough product made with a dough composition of the present invention is selected from the group consisting of a hoagie roll, a French bread loaf, and a Kaiser roll.

Tables 1-3 include exemplary ingredients and ranges for such ingredients for dough compositions of the present invention where the cooked dough products made such compositions have different sizes. A suitable procedure for mixing the formulations of Tables 1-3 includes 1) combining all ingredients and then mixing on low speed for 60 seconds, and 2) mixing on high speed (72 rpm) for 7 to 12 minutes. The mixed dough composition has a final temperature in the range from 62° F. to 79° F. and the dough rheology is such that it has a Brabender Farinograph value in the range from 700 to 1000 Brabender units.

Table 1 below illustrates an exemplary range of formulations for a small roll (e.g., Kaiser roll) having a size in the range from 1.25 to 4.5 ounces.

TABLE 1

| Ingredient | Bakers Percent* |
|---|---|
| Flour (hard wheat) | 100.00 |
| Water | 45 to 60 |
| High Fructose Corn Syrup | 1 to 15 |
| Soy Oil | 1 to 2 |
| Crumbled Yeast | 7.5 to 12.5 |
| Salt | 1.5 to 2 |
| Dough Conditioner | 0.25 to 1 |
| Ascorbic Acid | 120 to 200 ppm |
| Glucose Oxidase | 200 to 400 ppm |
| Baking Powder | 0 to 1.5 |

*All ingredients are given in Baker's percent, except Ascorbic Acid and Glucose Oxidase are given in ppm.

Table 2 below illustrates an exemplary range of formulations for a Sub roll (e.g., hoagie) having a size in the range from 5 to 13.5 ounces.

TABLE 2

| Ingredient | Bakers Percent* |
|---|---|
| Flour (hard wheat) | 100.00 |
| Water | 45 to 60 |
| High Fructose Corn Syrup | 1 to 15 |
| Soy Oil | 1 to 2 |
| Crumbled Yeast | 7.5 to 12.5 |
| Salt | 1.5 to 2 |
| Dough Conditioner | 0.25 to 1 |
| Ascorbic Acid | 120 to 200 ppm |
| Glucose Oxidase | 200 to 400 ppm |
| Baking Powder | 0.5 to 1.5 |

*All ingredients are given in Baker's percent, except Ascorbic Acid and Glucose Oxidase are given in ppm.

Table 3 below illustrates an exemplary range of formulations for a large loaf (e.g., French bread loaf) having a size in the range from 14 to 24 ounces.

TABLE 3

| Ingredient | Bakers Percent* |
|---|---|
| Flour (hard wheat) | 100.00 |
| Water | 45 to 60 |
| High Fructose Corn Syrup | 1 to 15 |
| Soy Oil | 1 to 2 |
| Crumbled Yeast | 7.5 to 12.5 |
| Salt | 1.5 to 2 |
| Dough Conditioner | 0.25 to 1 |
| Ascorbic Acid | 120 to 200 ppm |
| Glucose Oxidase | 200 to 400 ppm |
| Baking Powder | 1.5 |

*All ingredients are given in Baker's percent, except Ascorbic Acid and Glucose Oxidase are given in ppm.

While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

Table 4 below illustrates an exemplary range of formulations for a white sandwich roll (e.g., Hoagie bun) having a size in the range from 215 to 245 grams raw weight.

TABLE 4

| Ingredient | Bakers Percent |
|---|---|
| Flour | 100.00 |
| Water | 45 to 60 |
| High Fructose Corn Syrup | 1 to 8 |
| Soy Oil | 0.25 to 4 |
| Crumbled Yeast | 8 to 13 |
| Salt | 1.5 to 2.5 |
| Dough Conditioner | 0.25 to 1 |
| Xanthan gum | 0.1 to 1 |
| Vital wheat gluten | 0.1 to 3 |
| FUNGAMYL ® SUPER BR | 0.005 to 0.04 |
| Baking Powder | 0.5 to 1.5 |
| Glucose oxidase units (GODU units | 2.2 to 17.6 |
| from FUNGAMYL) per 100 g flour | |
| Alpha amylose units (FAU-F units | 1.5 to 12 |
| from FUNGAMYL) per 100 g flour | |

These rolls were processed by standard methods to produce dough pieces that exhibited retarder-to-oven proofing and baking properties, with good baked specific volume. E.g.,:

Bake Preparation: Place frozen products on trays in covered rack. Retard @ 40° F. for 18 hours. Remove from retarder and let temper at room temperature for 60 min. Score and bake at 350° F. for 15-20 min in rack oven with 40 s steam.

Average RSV out of retarder: 3.5 mL/g

Average BSV of baked product: 7.1 mL/g

Table 5 below illustrates an exemplary range of formulations for a white sandwich roll (e.g., Kaiser roll) having a size in the range from 75 to 85 grams raw weight.

TABLE 5

| Ingredient | Bakers Percent |
|---|---|
| Flour | 100.00 |
| Water | 40 to 50 |
| High Fructose Corn Syrup | 3 to 10 |
| Soy Oil | 2 to 7 |
| Cream Yeast | 17 to 25 |
| Salt | 1.5 to 2.5 |
| Dough Conditioner | 0.5 to 1.5 |
| FUNGAMYL ® SUPER BR | 0.01 to 0.04 |
| Glucose oxidase units (GODU units | 4.4 to 17.6 |
| from FUNGAMYL) per 100 g flour | |
| Alpha amylose units (FAU-F units | 3 to 12 |
| from FUNGAMYL) per 100 g flour | |

These rolls were processed by standard methods to produce dough pieces that exhibited retarder-to-oven proofing and baking properties, with good baked specific volume. E.g.,:

Bake Preparation: Place dough pieces on parchment lined pan. Retard covered @40° F. 20 for 14, 19, or 24 hours. Remove from retarder and let temper at room temperature for 60 min. Bake at 350° F. for 12-17 min in rack oven with 40 s steam.

Avg BSV—14 hour retard: 6.3 mL/g

Avg BSV—19 hour retard: 6.5 mL/g

Avg BSV—24 hour retard: 7.4 mL/g

Table 6 below illustrates an exemplary range of formulations for a wheat bread roll (e.g., dinner roll) having a size in the range from 38 to 48 grams raw weight.

TABLE 6

| Ingredient | Bakers Percent |
|---|---|
| Flour (white) | 70 to 90 |
| Whole Wheat Flour | 10 to 30 |
| Sum of white & wheat flours | 100 |
| Cracked Wheat | 3 to 10 |
| Wheat Bran | 2 to 8 |
| Water | 55 to 65 |
| High Fructose Corn Syrup | 5 to 15 |
| Soy Oil | 3 to 7 |
| Crumbled Yeast | 10 to 17 |
| Salt | 1.5 to 2.5 |
| Dough Conditioner | 0.25 to 1 |
| Xanthan gum | 0.1 to 1 |
| Vital wheat gluten | 1 to 5 |
| FUNGAMYL ® SUPER BR | 0.01 to 0.04 |
| Molasses | 0.5 to 5 |
| Raisin Juice | 0.3 to 3 |
| Glucose oxidase units (GODU units | 4.4 to 17.6 |
| from FUNGAMYL) per 100 g flour | |
| Alpha amylose units (FAU-F units | 3 to 12 |
| from FUNGAMYL) per 100 g flour | |

These rolls were processed by standard methods to produce dough pieces that exhibited retarder-to-oven proofing and baking properties, with good baked specific volume. E.g.,:

Bake Preparation: Place dough pieces on parchment lined pan. Retard covered @40° F. for 16 hours. Remove from retarder and let temper at room temperature for 60 min.

Bake @350° F. for 12-17 min. in rack oven with 40 s steam.

Average BSV: 6.3 mL/g

Table 7 below illustrates an exemplary range of formulations for a white bread (e.g., French bread) having a size in the range from 520 to 570 grams raw weight.

TABLE 7

| Ingredient | Bakers Percent |
|---|---|
| Flour | 100.00 |
| Water | 45 to 60 |
| High Fructose Corn Syrup | 1 to 6 |
| Soy Oil | 0.5 to 3 |
| Crumbled Yeast | 9 to 13 |
| Salt | 1.5 to 2.5 |
| Dough Conditioner | 0.25 to 1 |
| Xanthan gum | 0.1 to 1 |
| Vital wheat gluten | 0.1 to 3 |
| FUNGAMYL ® SUPER BR | 0.02 to 0.05 |
| Baking Powder | 0.25 to 1.5 |
| Glucose oxidase units (GODU units | 8.8 to 22 |
| from FUNGAMYL) per 100 g flour | |
| Alpha amylose units (FAU-F units | 6 to 15 |
| from FUNGAMYL) per 100 g flour | |

Doughs of this formulation were processed by standard methods to produce dough pieces that exhibited retarder-to-oven proofing and baking properties, with good baked specific volume.

Table 8 below illustrates an exemplary range of formulations for a wheat sandwich roll (e.g., Hoagie bun) having a size in the range from 215 to 245 grams raw weight.

TABLE 8

| Ingredient | Bakers Percent |
|---|---|
| Flour (white) | 70 to 90 |
| Whole Wheat Flour | 10 to 30 |
| Sum of white & wheat flours | 100 |
| Cracked Wheat | 3 to 10 |
| Wheat Bran | 2 to 8 |
| Water | 55 to 65 |
| High Fructose Corn Syrup | 5 to 15 |
| Soy Oil | 3 to 7 |
| Crumbled Yeast | 10 to 17 |
| Salt | 1.5 to 2.5 |
| Dough Conditioner | 0.25 to 1 |
| Xanthan gum | 0.1 to 1 |
| Vital wheat gluten | 1 to 5 |
| FUNGAMYL ® SUPER BR | 0.01 to 0.04 |
| Molasses | 0.5 to 5 |
| Raisin Juice | 0.3 to 3 |
| Glucose oxidase units (GODU units | 4.4 to 17.6 |
| from FUNGAMYL) per 100 g flour | |
| Alpha amylose units (FAU-F units | 3 to 12 |
| from FUNGAMYL) per 100 g flour | |

Doughs of this formulation were processed by standard methods to produce dough pieces that exhibited retarder-to-oven proofing and baking properties, with good baked specific volume.

Table 9 below illustrates an exemplary range of formulations for a wheat bread (e.g., French bread) having a size in the range from 520 to 570 grams raw weight.

TABLE 9

| Ingredient | Bakers Percent |
|---|---|
| Flour (white) | 70 to 90 |
| Whole Wheat Flour | 10 to 30 |
| Sum of white & wheat flours | 100 |
| Cracked Wheat | 3 to 10 |
| Wheat Bran | 2 to 8 |
| Water | 55 to 65 |
| High Fructose Corn Syrup | 3 to 12 |
| Soy Oil | 2 to 6 |
| Crumbled Yeast | 10 to 17 |
| Salt | 1.5 to 2.5 |
| Dough Conditioner | 0.5 to 1.5 |
| Xanthan gum | 0.1 to 1 |
| Vital wheat gluten | 3 to 7 |
| FUNGAMYL ® SUPER BR | 0.01 to 0.04 |
| Molasses | 0.5 to 5 |
| Raisin Juice | 0.3 to 3 |
| Glucose oxidase units (GODU units | 4.4 to 17.6 |
| from FUNGAMYL) per 100 g flour | |
| Alpha amylose units (FAU-F units | 3 to 12 |
| from FUNGAMYL) per 100 g flour | |

Doughs of this formulation were processed by standard methods to produce dough pieces that exhibited retarder-to-oven proofing and baking properties, with good baked specific volume.

Table 10 below illustrates an exemplary range of formulations for a wheat sandwich roll (e.g., Kaiser roll) having a size in the range from 75 to 85 grams raw weight.

TABLE 10

| Ingredient | Bakers Percent |
|---|---|
| Flour (white) | 70 to 90 |
| Whole Wheat Flour | 10 to 30 |
| Sum of white & wheat flours | 100 |
| Cracked Wheat | 3 to 10 |
| Wheat Bran | 2 to 8 |
| Water | 55 to 65 |
| High Fructose Corn Syrup | 3 to 12 |
| Soy Oil | 2 to 6 |
| Crumbled Yeast | 10 to 17 |
| Salt | 1.5 to 2.5 |
| Dough Conditioner | 0.5 to 1.5 |
| Xanthan gum | 0.1 to 1 |
| Vital wheat gluten | 2 to 5 |
| FUNGAMYL ® SUPER BR | 0.01 to 0.04 |
| Molasses | 0.5 to 5 |
| Raisin Juice | 0.3 to 3 |
| Glucose oxidase units (GODU units | 4.4 to 17.6 |
| from FUNGAMYL) per 100 g flour | |
| Alpha amylose units (FAU-F units | 3 to 12 |
| from FUNGAMYL) per 100 g flour | |

Doughs of this formulation were processed by standard methods to produce dough pieces that exhibited retarder-to-oven proofing and baking properties, with good baked specific volume.

1. A frozen, unproofed, developed dough composition comprising
yeast in an amount in the range from 2 to 6 Baker's percent on a dry yeast basis; and
dough-strengthening enzyme,
wherein the dough composition is capable of proofing at retarder conditions.

2. The composition of claim 1 wherein the enzyme is selected from the group consisting of glucose oxidase, lypoxygenase, hexose oxidase, lipase, and combinations thereof.

3. The composition of claim 1 wherein the enzyme is glucose oxidase.

4. The composition of claim 1 wherein the enzyme comprises glucose oxidase and amylase.

5. The composition of claim 1 comprising from 2 to 30 glucose oxidase units per 100 grams flour.

6. The composition of claim 1 comprising acidic chemical leavening agent and basic chemical leavening agent.

7. The composition of claim 6 wherein the acidic chemical leavening agent is sodium aluminum phosphate.

8. The composition of claim 1 comprising from 0.1 to 1 Baker's percent thickener.

9. The composition of claim 1 comprising from 0.1 to 10 Baker's percent concentrated protein ingredient.

10. The composition of claim 1 comprising high protein flour.

11. The composition of claim 1 wherein the dough composition comprises:
from 30 to 70 percent high protein flour,
from 2 to 30 glucose oxidase units per 100 grams flour,
from 0.1 to 10 Baker's percent vital wheat gluten, and
from 0.1 to 1 Baker's percent thickener.

12. The composition of claim 1 comprising from 3 to 5 percent yeast on a dry basis.

13. The composition of claim 1 wherein the dough can be baked without exhibiting either internal blow-out or external blow-out.

14. The composition of claim 1 wherein the dough does not include any acidic chemical leavening agent and does not include any basic chemical leavening agent.

15. The composition of claim 14 wherein the dough can be baked without exhibiting either internal blow-out or external blow-out.

16. A method of proofing a frozen, unproofed, developed dough composition, comprising:
providing a frozen, unproofed, developed dough comprising
yeast in an amount in the range from 2 to 6 Baker's percent on a dry yeast basis; and
dough-strengthening enzyme,
thawing and proofing the frozen dough composition at retarder conditions for a time in the range from 8 to 48 hours;
placing the dough at ambient temperature in the range from 65 to 85 degrees Fahrenheit for a time of less than 60 minutes and
baking the proofed dough.

17. The method of claim 16 comprising placing the dough at ambient temperature for a time in the range from 30 to 60 minutes.

18. The method of claim 16 wherein upon removal from the proofer the dough product has a raw specific volume in the range from 2.5 to 5 cubic centimeters per gram.

19. The method of claim 16 comprising the step of, after proofing, cooking the proofed dough composition to provide a cooked dough product.

20. A cooked dough product made by the method of claim 19 wherein the cooked dough product has a baked specific volume in the range from 4 to 8 cubic centimeters per gram.
